(19) United States
(12) Patent Application Publication
(10) Pub. No.: US 2008/0189201 A1
(43) Pub. Date: Aug. 7, 2008

(54) METHOD FOR PROVIDING COMPARATIVE AUCTION RESULTS ON A WEBSITE

(75) Inventors: Moti REDMARD, Tel Aviv (IL); Avital MAHABASH, Ramla (IL)

Correspondence Address: Moti Redmard, 45/2 Shmuel Tamir St., Tel Aviv, 69637, omitted

(73) Assignee: OLPRICE LTD., Tel Aviv (IL)

(21) Appl. No.: 11/671,203

(22) Filed: Feb. 5, 2007

(51) Int. Cl. G06Q 40/00

(52) U.S. Cl. 705/37

(57) ABSTRACT

A method of determining and providing a plurality of interested consumers with an optimal low price and the corresponding auction Website for at least one particular product of interest. The method includes compiling a list of a plurality of active auction Website links. The method also includes determining the lowest winning price among the plurality of auction Website links for a plurality of products and making available to a plurality of interested consumers the lowest winning price among the plurality of auction Website links for at least one particular product of interest to each of the plurality of interested consumers, such that each of the plurality of interested consumers is able to bid the lowest winning price for the at least one particular product of interest.

### FIELD OF THE INVENTION

The present invention relates to online auctions, and more particularly, to a method for determining and providing an optimum online auction low bid price and a corresponding Website to enter the bid.

### BACKGROUND OF THE INVENTION

Products such as TV's and appliances can traditionally be bought in physical stores. With the advent of the Internet, virtual stores have generally offered lower prices because of low overhead. Public auctions sites on the Internet have been popular for many years, and even lower prices are usually found in this venue. Various products for use with tandem auctions are available on Internet sites around the clock. Human participation is limited for following up the auctions, in terms of reviewing and analyzing the winning bid results.

Comparative price Web sites are also now available for displaying regular Internet sales and for displaying auctions sites. Such comparative sites only show the minimum required starting prices or current prices of products at auctions on the Internet. In most cases the minimum starting prices are higher than the price for which one can win the product at another auction, whether at the same site or at another site.

Also in most cases the prices at auctions sites on the Internet are lower than prices of products without auction, for example at a regular Internet sale, a virtual store. Comparative price Web sites are financed by means of the stores, to promote only their products. There are also sites that provide links both to virtual stores and online auctions.

The winning prices at public auction sites are usually lower than the prices at virtual stores. The virtual stores undercut the street market because of low Internet overhead costs.

Another feature of Internet shopping is that the minimum bids for participants in online auctions are sometimes hidden. Therefore consumers generally bid higher than the absolutely lowest price required to win the auction.

Thus, it would be advantageous to consumers to have access to information about Websites having the highest likelihood of the lowest possible price for currently desired products.

### SUMMARY OF THE INVENTION

Accordingly, it is a principal object of the present invention to provide access for consumers to information about Websites having the highest likelihood of the lowest possible price for currently desired products.

It is another principal object of the present invention to provide a method to collect online auction results in real time from all the sites on varied products.

It is a further principal object of the present invention to provide a method that scans online auction Websites, deciphers the bids, extracts the winning bids and ignores bids that are not final.

A method is described for determining and providing a plurality of interested consumers with an optimal low price and the corresponding auction Website for at least one particular product of interest. The method includes compiling a list of a plurality of active auction Website links. The method also includes determining the lowest winning price among the plurality of auction Website links for a plurality of products and making available to a plurality of interested consumers the lowest winning price among the plurality of auction Website links for at least one particular product of interest to each of the plurality of interested consumers, such that each of the plurality of interested consumers is able to bid the lowest winning price for the at least one particular product of interest.

Research in collecting and analyzing prices has shown that variations in the winning bids over a series of auctions for the same product at the same site are low and the variations are high between sites for the same product. Thus, the winning price generally remains steady at the same site and is generally very much lower or higher than at other sites. So a customer can confidently choose the site with the lowest winning auction price and participate in the next auction by bidding at or near the same price.

Each site has some products that are lower in price that at other sites, so he can choose the best site for the product for which he is looking.

The present invention provides a Website for presentation of comparative winning results. The Website provides collection and analysis of online auction winning prices in real time and online updating and presentation of the lowest winning prices, numbers which are not otherwise available for customers.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a schematic block illustration of a system used to implement a method for providing a Website for determining and presenting an optimum online auction low bid price and the corresponding auction site, and for allowing customers to enter a similar low bid at the same auction site, constructed in accordance with the principles of the present invention; and

FIG. 2 is a flow chart exemplifying a method for providing a Website for determining and presenting an optimum online auction low bid price and the corresponding auction site, and for allowing customers to enter a similar low bid at the same auction site, constructed in accordance with the principles of the present invention.

### DETAILED DESCRIPTION OF AN EXEMPLARY EMBODIMENT

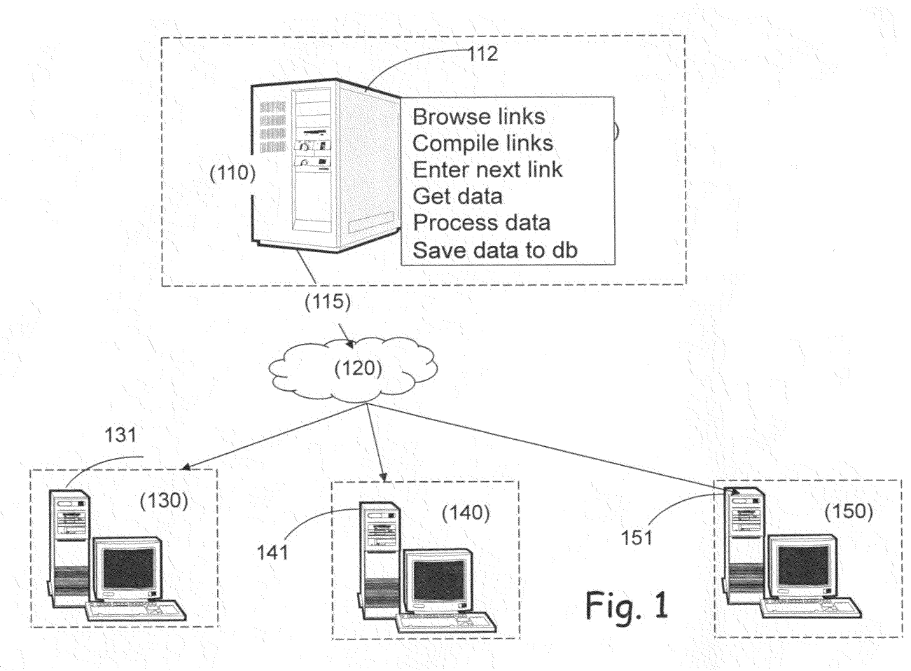

FIG. 1 is a schematic block illustration of a system used to implement a method for providing a Website for determining and presenting an optimum online auction low bid price and the corresponding auction site, and for allowing customers to enter a similar low bid at the same auction site. The system is preferably embodied in a Website 110, having a server with a database 112. An application 114 is implemented 115, via the Internet 120 to build and maintain links from all auction Websites 130, 140 and 150, with corresponding auction databases 131, 141 and 151.

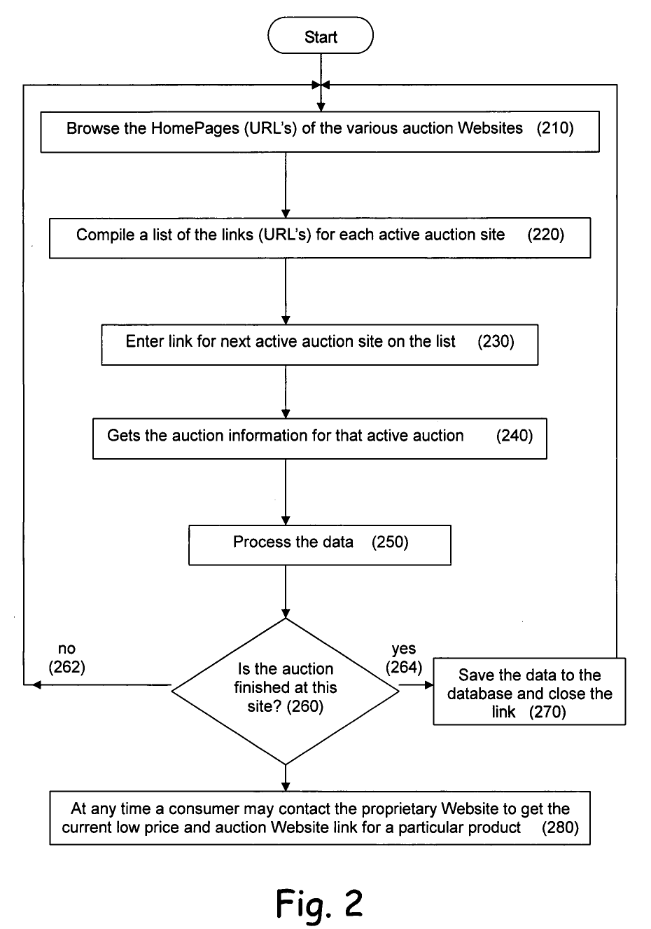

FIG. 2 is a flow chart exemplifying a method for providing a Website for determining and presenting an optimum online auction low bid price and the corresponding auction site, and for allowing customers to enter a similar low bid at the same auction site, constructed in accordance with the principles of the present invention, constructed in accordance with the principles of the present invention. Application 114 referenced in FIG. 1, begins cyclic monitoring by browsing the HomePage URL's of the various auction Websites 210. Then the application compiles or recompiles a list of the links (URL's) for each active auction site 220, enters the link for the next auction site 230 and gets the auction information for that active auction Website 240. Subsequently the data is processed by the application 250. It then determines whether the auction is finished at this site 260. If not, the monitoring cycle repeats 262. If the auction is finished at this site 264 the data is saved to the database, that link is closed and the monitoring cycle repeats 270.

At any time a consumer may contact the proprietary Website to get the current low price and corresponding auction Website link for a particular product 280. The consumer may place the bid himself or instruct the proprietary Website agent, whether a human agent or a server agent, to place the bid. Before the closing at auction Website an even lower price may become known, in which the agent will preferably act on this new information instead.

Each auction site generally has an agent also. The agent at the proprietary Website can give the consumer's credit details to buy at the right time or can send the consumer an SMS message or e-mail, etc., when it is time to place his bid. Thus, the agent is available to act as the consumer's agent for participation in any and all auction Websites.

The information that the proprietary Website makes available to the consumer for a particular product includes the lowest winning bid with the corresponding auction Website link, auction frequency, dates and prices of all previous auction results from substantially all auction Websites and product descriptions.

Proprietary Website 110 of the system provided by the present invention has the following unique features:
system automatically scans and stores the closing prices without manual involvement;
system automatically finds all links to public auctions in chosen auction Websites and is not liable to manufacturer, supplier or the auction Website to supply the information;
system must be quick, since closing prices are generally deleted within a few hours of the auction's end, but at some auction Websites sometimes within 2 minutes;
proprietary Website 110 stores the auctioned products descriptions, closing prices, auction Website name, product lowest closing price etc;
user can receive an alert for purchase on an auction that is about to close at a historically low price;
proprietary Website 110 displays auctions frequencies and the low attractive price for a product in all chosen auction Websites;
auction frequency and the product price will determine the choice of the auction Website; and
analysis of succeeding auction results provides ever-closer values to any hidden minimums, and the latest value is made available to consumers visiting proprietary Website 110.

The following database collection methods are feasible:
1. A computerized system scans all links to auctions at auctions Websites and automatically stores the final prices;
2. Manually scan and collect information at all public auction Websites, viewing every auction closing and manually recording the details in the database; this generally requires a number of personnel;
3. Video or computerized footage of each auction Website is taped and manually recorded by reviewing or scanning the footage and analyzing the results; and
4. Receiving the final prices from the auction Websites, wherein the auction Websites themselves provide delivery.
5. Any or all of the above.

It is to be understood that the phraseology and terminology employed herein are for the purpose of description, and should not be regarded as limiting.

It is important, therefore, that the scope of the invention is not construed as being limited by the illustrative embodiments set forth herein. Other variations are possible within the scope of the present invention as defined in the appended claims and their equivalents.

We claim:

1. A method of determining and providing a plurality of interested consumers with an optimal low price and the corresponding auction Website for at least one particular product of interest, said method comprising:
compiling a list of a plurality of active auction Website links;
determining the lowest winning price among said plurality of auction Website links for a plurality of products; and
making available to a plurality of interested consumers the lowest winning price among said plurality of auction Website links for at least one particular product of interest to each of said plurality of interested consumers,
such that each of said plurality of interested consumers is able to bid said lowest winning price for said at least one particular product of interest.

2. The method of claim 1, further comprising browsing the homepages of various auction Websites in order to find active auction Websites, prior to said compiling step.

3. The method of claim 1, wherein said compiling is provided by a computerized system that scans said plurality of active auction Website links and automatically stores the final winning prices.

4. The method of claim 1, wherein said compiling comprises:
computerized digital recording each of said plurality of active auction Website links;
reviewing the digitally recorded footage of each of said plurality of active auction Website links; and
analyzing the results of said reviewing.

5. The method of claim 1, wherein said compiling comprises:
videotaping each of said plurality of active auction Website links;
reviewing the videotape footage of each of said plurality of active auction Website links; and
analyzing the results of said reviewing.

6. The method of claim 1, wherein said compiling comprises:
manually scanning said plurality of active auction Website links;
viewing each active auction Website closing; and
manually recording the final winning prices.

7. The method of claim 1, wherein said determining step further comprises:
entering the link for each active auction Website on said list; and
getting the auction information for each of said active auction Websites.

8. A method of determining and providing a plurality of interested consumers with an optimal low price and the corresponding auction Website for at least one particular product of interest, said method comprising:
getting the low prices from the auction Website providers; and
making available to a plurality of interested consumers the lowest winning price among said plurality of auction Website links for at least one particular product of interest to each of said plurality of interested consumers,
such that each of said plurality of interested consumers is able to bid said lowest winning price for said at least one particular product of interest.
